(19) United States
(12) Patent Application Publication
(10) Pub. No.: US 2018/0103419 A1
(43) Pub. Date: Apr. 12, 2018

(54) METHOD AND APPARATUS FOR CHANGING A COVERAGE ENHANCEMENT MODE

(71) Applicant: LG ELECTRONICS INC., Seoul (KR)

(72) Inventors: Jaewook Lee, Seoul (KR); Youngdae Lee, Seoul (KR)

(21) Appl. No.: 15/567,195

(22) PCT Filed: Apr. 19, 2016
(86) PCT No.: PCT/KR2016/004061

§ 371 Date: Oct. 17, 2017

Related U.S. Application Data
(60) Provisional application No. 62/149,648, filed on Apr. 19, 2015.

(51) Int. Cl. H04W 48/12; H04W 16/26; H04W 72/08

(52) U.S. Cl. CPC H04W 48/12; H04L 5/001; H04W 72/085; H04W 16/26

(57) ABSTRACT

A method for changing a coverage enhancement mode in a wireless communication system supporting a coverage enhancement (CE) is disclosed. For this, the method comprising: receiving, from a network, information on a CE mode level supported by the network, wherein the information on the supported CE mode level indicates a highest level among CE mode levels currently supported by the network; determining a CE mode level of the UE; and transmitting, to the network, a first message for requesting a change of the supported CE mode level, when the determined CE mode level of the UE is higher than or equal to the supported CE mode level.

### TECHNICAL FIELD

The present invention relates to wireless communications, and more particularly, to a method and apparatus for changing a coverage enhancement mode.

### BACKGROUND ART

Wireless communication systems are widely developed to provide a various kinds of communication services such as audio or data service. In general, a wireless communication system is a multiple access system capable of supporting communications with multiple users by sharing available system resources (bandwidths, transmission power, etc.). Examples of the multiple access system include a CDMA (Code Division Multiple Access) system, FDMA (Frequency Division Multiple Access) system, TDMA (Time Division Multiple Access) system, OFDMA (Orthogonal Frequency Division Multiple Access) system, SC-FDMA (Single Carrier Frequency Division Multiple Access) system, MC-FDMA (Multi-Carrier Frequency Division Multiple Access) system, etc.

### DISCLOSURE

### Technical Problem

Based on the above-mentioned discussion, methods for changing a coverage enhancement mode and apparatuses therefor shall be proposed in the following description.

Technical tasks obtainable from the present invention are non-limited by the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, a method for changing, by a user equipment (UE), a coverage enhancement (CE) mode in a wireless communication system, the method comprising: receiving, from a network, information on a CE mode level supported by the network, wherein the information on the supported CE mode level indicates a highest level among CE mode levels currently supported by the network; determining a CE mode level of the UE; and transmitting, to the network, a first message for requesting a change of the supported CE mode level, when the determined CE mode level of the UE is higher than or equal to the supported CE mode level.

In accordance with another aspect of the present invention, a user equipment (UE) in a wireless communication system, the UE comprising: a radio frequency (RF) module configured to transmit/receive signals to/from a network; and a processor configured to process the signals, wherein the processor determines a CE mode level of the UE and controls the RF module to transmit, to the network, a first message for requesting a change of a supported CE mode level received from the network, when the determined CE mode level of the UE is higher than or equal to the supported CE mode level, wherein the supported CE mode level indicates a highest level among CE mode levels currently supported by the network.

Preferably, a CE mode level defines a repetition number of a downlink transmission from the network

Preferably, a repetition number of a downlink transmission is increased in accordance with an increase of a CE mode level.

The method further comprising: transmitting, to the network, a second message including information on the determined CE mode level of the UE, when the determined CE mode level of the UE is lower than or equal to the supported CE mode level.

The method further comprising: receiving, from the network, information on a maximum CE mode level, wherein the first message is transmitted only when the determined CE mode level of the UE is lower than or equal to the maximum CE mode level.

Preferably, the first message is transmitted through a random access preamble corresponding to the determined CE mode level.

Preferably, the CE mode level of the UE is determined based on comparing measured received signal reference power (RSRP) of the UE for a serving cell and RSRP thresholds corresponding to each CE mode level.

In accordance with another aspect of the present invention, a method of communication based on a coverage enhancement (CE) mode by a user equipment (UE) in a wireless communication system, the method comprising: receiving, from a network, information on a CE mode level of the UE via a physical downlink control channel (PDCCH); and performing a random access procedure using a random access resource selected based on the received CE mode level.

### Advantageous Effects

According to embodiments of the present invention, a user equipment can change a coverage enhancement mode in a wireless communication system.

It will be appreciated by persons skilled in the art that the effects that can be achieved with the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 shows a network structure of an E-UMTS (Evolved Universal Mobile Telecommunication System);

FIG. 2 shows structures of an E-UTRAN (Evolved Universal Terrestrial Radio Access Network) and a gateway;

FIGS. 3 and 4 show user/control plane protocols with respect to an E-UMTS;

FIG. 5 shows a structure of a radio frame used in an E-UMTS;

FIG. 6 illustrates an operation performed between a UE and an eNB in a contention-based random access procedure.

FIG. 7 shows an example of a method for changing a coverage enhancement mode according to an embodiment of the present invention.

FIG. 8 is a block diagram for one example of a communication device according to one embodiment of the present invention.

### BEST MODE

Configurations, operations and other characteristics of the present invention will be easily understood according to embodiments of the present invention, described with reference to the attached drawings. Though the following embodiments will describe a case in which technical characteristics of the present invention are applied to a 3GPP system, the embodiments are exemplary and the present invention is not limited thereto.

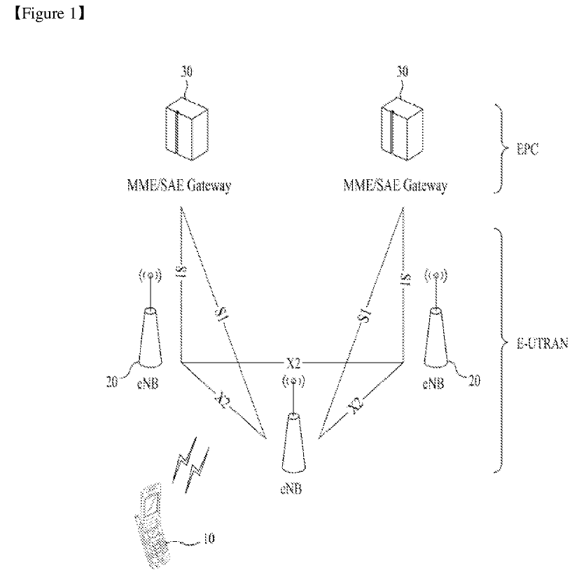

FIG. 1 shows a network structure of an E-UMTS. The E-UMTS is also referred to as a LTE system. A communication network is arranged in a wide range and provides various communication services such as audio and packet data service.

Referring to FIG. 1, an E-UMTS network includes an E-UTRAN (Evolved Universal Terrestrial Radio Access Network), an EPC (Evolved Packet Core), and one or more user equipments (UE). The E-UTRAN may include one or more base stations (eNB) 20. The one or more UEs 10 may be located in one cell. One or more E-UTRAN mobility management entity/system architecture evolution (MME/SAE) gateways 30 may be located at the end of the network and connected to an external network. In the specification, a downlink means transmission from the base station 20 to the UE 10 and an uplink means transmission from the UE 10 to the base station 20.

The UE 10 is a communication device carried by a user and may be referred to as a mobile station (MS), a user terminal (UT), a subscriber station (SS), or a radio device. Each base station 20 is a fixed station communicating with the UE 10 and may be referred to as an access point (AP). The base station 20 provides end points of a user plane and a control plane to the UE 10. One base station 20 may be located in each cell. An interface for transmitting user traffic or control traffic may be used between the base stations 20. Each MME/SAE gateway 30 provides end points of session and mobility management function to the UE 10. The base station 20 and the MME/SAE gateway 30 can be connected to each other through an S1 interface.

MME provides various functions including distribution of a paging message to the base stations 20, security control, idle state mobility control, SAE bearer control, and encryption of non-access stratum (NAS) layer signaling and integrity protection. An SAE gateway host provides various functions including completion of a plane packet and user plane switching for supporting mobility of the UE 10. The MME/SAE gateway 30 is simply referred to as a gateway in the specification. However, the MME/SAE gateway 30 includes both MME and SAE gateways.

A plurality of nodes may be connected through S1 interfaces between the gateways 30 and the base stations 20. The base stations 20 may be connected to each other through an X2 interface and neighbor base stations may have a mesh network structure with the X2 interface.

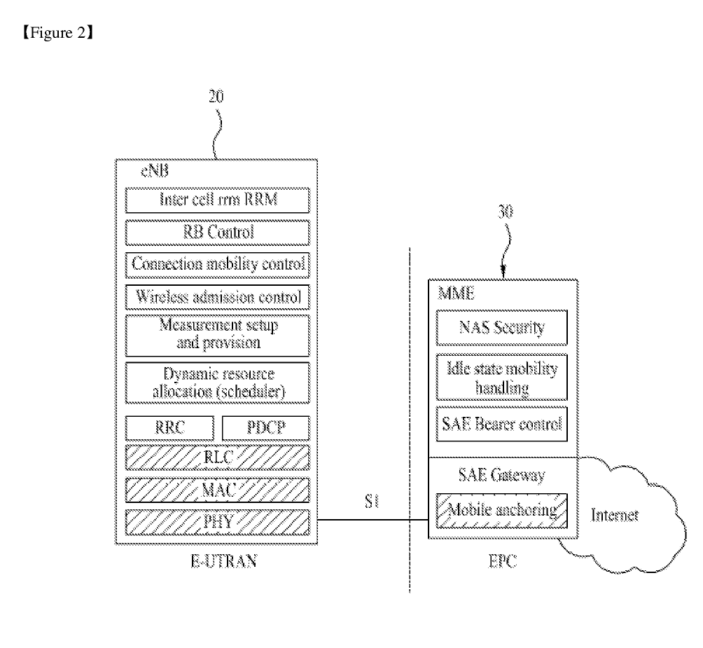

FIG. 2 shows structures of a general E-UTRAN and the general gateway 30. Referring to FIG. 2, the base station 20 can execute functions such as selection of the gateway 30, routing to the gateway during activation of radio resource control (RRC), scheduling and transmission of a paging message, scheduling and transmission of broadcast channel (BCCH) information, dynamic resource allocation for the UE 10 on both uplink and downlink, configuration and preparation of base station measurement, radio bearer control, radio admission control (RAC), and connection mobility control. The gateway 30 can perform functions such as paging transmission, LTE_IDLE state management, user plane encryption, system architecture evolution bearer control, encryption of NAS layer signaling and integrity protection.

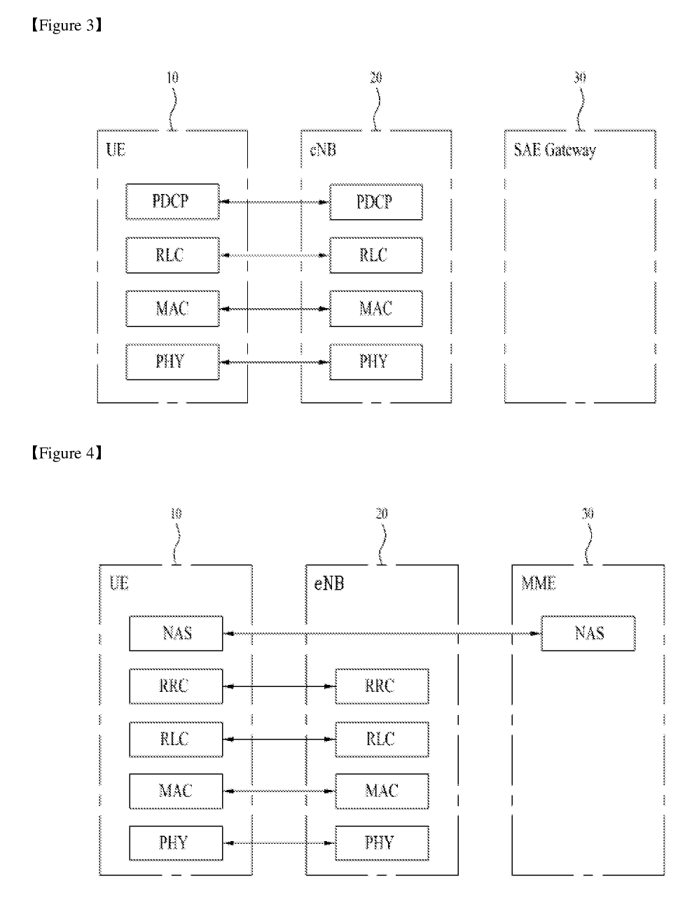

FIGS. 3 and 4 show user-plane protocol and control-plane protocol stacks for an E-UMTS. Referring to FIGS. 3 and 4, protocol layers can be divided into a first layer L1, a second layer L2, and a third layer L3 on the basis of lower three layers of the open system interconnection (OSI) standard model known in communication system technologies.

A physical layer PHY corresponding to the first layer L1 provides information transmission to an upper layer using a physical channel. The physical layer is liked to a medium access control (MAC) layer located at an upper level through a transmission channel, and data is transmitted between the physical layer and the MAC layer through the transmission channel. Data is transmitted between a physical layer of a transmitter and a physical layer of a receiver through a physical channel.

An MAC layer corresponding to the second layer L2 provides a service to a radio link control (RLC) layer corresponding to an upper layer through a logical channel. The RLC layer of the second layer L2 supports reliable data transmission. When the MAC layer performs an RLC function, the RLC layer is included in the MAC layer as a functional block. A PDCP (Packet Data Convergence Protocol) layer of the second layer L2 performs a header compression function. The header compression function efficiently transmits an Internet protocol (IO) packet such as IPv4 or IPv6 through a radio interface having a relatively narrow bandwidth.

A radio resource control (RRC) layer located at the lowest level of the third layer L3 is defined for a control plane only. The RRC layer controls a logical channel, a transmission channel and a physical channel with respect to setup, re-setup and cancellation of radio bearers (RBs). A radio bearer (RB) means a service provided by the second layer L2 for data transmission between the UE 10 and the E-UTRAN.

Referring to FIG. 3, the RLC layer and the MAC layer are finished in the base station 20 and can perform functions such as scheduling, automated retransmission request (ARQ) and hybrid automated retransmission request (HARQ). The PDCP layer is finished in the base station 20 and can execute functions such as header compression, integrity protection and encryption.

Referring to FIG. 4, the RLC layer and the MAC layer are completed in the base station 20 and perform the same function as those in the control plane. As shown in FIG. 3, the RRC layer is finished in the base station 20 and can perform functions such as broadcasting, paging, RRC connection management, radio bearer control, mobility function, and UE measurement report and control. As shown in FIG. 2(c), a NAS control protocol is finished in MME of the gateway 30 and can execute functions such as SAE bearer management, authentication, LTE_IDLE mobility handling, paging transmission in LTE_IDLE state, and security control for signaling between the gateway and the UE 10.

The NAS control protocol can use three states. A LTE-DETACHED state is used when RRC entity is not present. A LTE_IDLE state stores minimum UE information and is used when RRC connection is not present. A LTE_ACTIVE state is used when RRC state is set up. The RRC state is divided into RRC_IDLE and RRC_COMMECTED states.

In the RRC_IDLE state, the UE 10 perform discontinuous receiving (DRX) set by NAS using ID uniquely allocated thereto in a tracking region. That is, the UE 10 can receive broadcast of system information and paging information by monitoring a paging signal on a specific paging occasion for each UE-specific paging DRX cycle. In the RRC_IDLE state, no RRC context is stored in the base station.

In the RRC_CONNECTED state, the UE 10 can transmit/receive data to/from the base station using E-UTRAN RRC connection and context in E-UTRAN. Furthermore, the UE 10 can report channel quality information and feedback information to the base station. In the RRC_CONNECTED state, the E-UTRAN is aware of the cell to which the UE 10 belongs. Accordingly, the corresponding network can transmit and/or receive data to and/or from the UE 10, control mobility of the UE, such as a handover, and perform cell measurement with respect to neighboring cells.

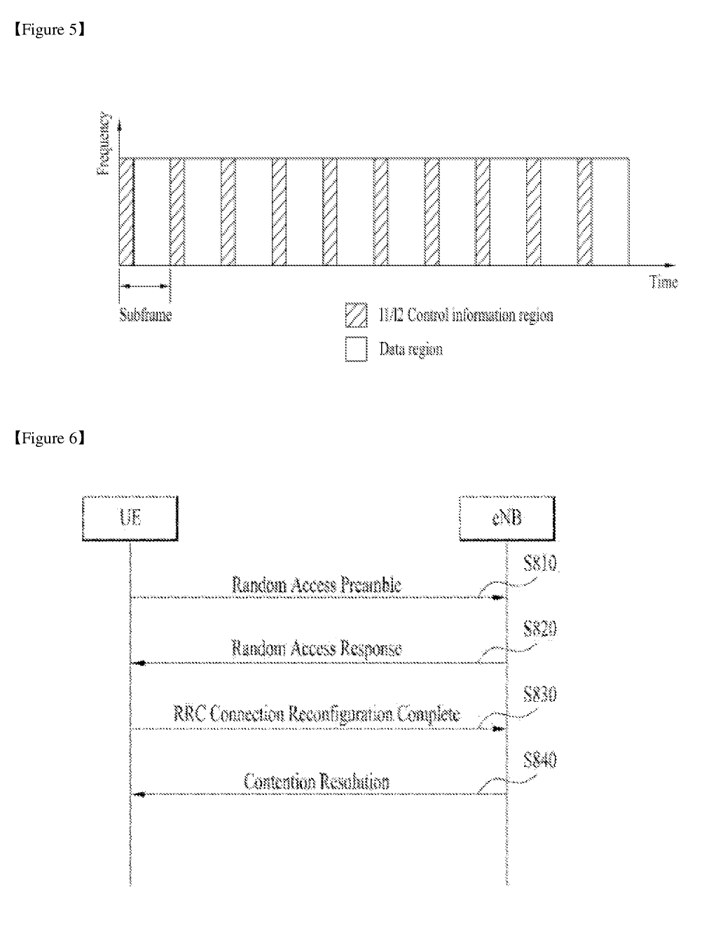

FIG. 5 shows a structure of a radio frame used in an E-UMTS.

Referring to FIG. 5, the E-UMTS uses a radio frame of 10 ms. One radio frame includes ten subframes. One subframe has two continuous slots. The length of one slot is 0.5 ms. Furthermore, one subframe is composed of a plurality of symbols (for example, OFDM symbols, SC-FDMA symbols, etc.). One subframe is composed of a plurality of resource blocks, and one resource block includes a plurality of symbols and a plurality of subcarriers. Some (for example, a first symbol) of the plurality of symbols constituting one subframe can be used to transmit L1/L2 control information. A physical channel (for example, PDCCH (Physical Downlink Control Channel)) transmitting the L1/L2 control information is composed of subframes on the time domain and subcarriers on the frequency domain.

FIG. 6 illustrates an operation performed between a UE and an eNB in a contention-based random access procedure.

(1) Transmission of First Message (Msg1)

The UE may randomly select a Random Access Preamble from a set of Random Access Preambles indicated by system information or a Handover Command message, select Physical RACH (PRACH) resources, and transmit the selected Random Access Preamble in the PRACH resources to the eNB (S610).

(2) Reception of Second Message (Msg2)

After transmitting the random access preamble in step S610, the UE attempts to receive a Random Access Response (RAR) message within a random access response reception window indicated by the system information or the Handover Command message from the eNB (S620).

The RAR message may be transmitted in a Medium Access Control (MAC) Packet Data Unit (PDU) and the MAC PDU may be transmitted on a PDSCH in step S620. To receive information on the PDSCH successfully, the UE preferably monitors a Physical Downlink Control Channel (PDCCH).

The PDCCH may deliver information about a UE to receive the PDSCH, time and frequency information about radio resources of the PDSCH as resource allocation information, and information about the transport format of the PDSCH. Once the UE successfully receives the PDCCH directed to it, the UE may appropriately receive an RAR on the PDSCH based on information of the PDCCH. The RAR may include a Random Access Preamble Identifier (RAPID), an UpLink (UL) Grant indicating UL radio resources, a Temporary Cell-Radio Network Temporary Identifier (C-RNTI), and a Timing Advance Command (TAC).

The reason for including the RAPID in the RAR is that one RAR may include RAR information for one or more UEs and thus it is necessary to indicate a UE for which the UL Grant, the Temporary C-RNTI, and the TAC are valid. Herein, it is assumed that the UE selects an RAPID matching the Random Access Preamble selected by the UE.

(3) Transmission of Third Message (Msg 3)

If the UE receives an RAR message valid for it, the UE processes information included in the RAR message. That is, the UE applies a RAC and stores the Temporary C-RNTI. In addition, the UE may store data to be transmitted in response to the valid RAR reception in an Msg 3 buffer.

Meanwhile, the UE transmits data (i.e. a third message) to the eNB based on the received UL Grant. That is, the UE transmits a third message in UL resources allocated by the UL Grant to the eNB (S630).

The third message should include an ID of the UE. In the contention-based random access procedure, the eNB may not determine which UE is performing the random access procedure and should identify the UE to resolve collision later. The third message may be an RRC Connection Request message or an RRC Connection Reconfiguration Complete message.

(4) Reception of Fourth Message

After transmitting the data including its ID based on the UL Grant included in the RAR, the UE receives a Contention Resolution message on a DL-SCH from the eNB (S640).

From the perspective of the physical layer, a Layer 1 (L1) random access procedure refers to transmission and reception of a Random Access Preamble and an RAR message in steps S610 and S620. The other messages are transmitted on a shared data channel by a higher layer, which is not considered to fall into the L1 random access procedure.

In the above RACH procedure, an RACH includes 6 RBs in one or more contiguous subframes reserved for transmission of a Random Access Preamble. The L1 random access procedure is triggered by a preamble transmission request from a higher layer. A preamble index, a target preamble reception power PREAMBLE_RECEIVED_TARGET_POWER, a matching RA_RNTI, and PRACH resources are part of the preamble transmission request, indicated by the higher layer.

A preamble sequence is selected from a preamble sequence set, using a preamble index. A single preamble is transmitted in PRACH resources indicated by the transmission power PPRACH using the selected preamble sequence.

Detection of a PDCCH indicated by the RA-RNTI is attempted within a window controlled by the higher layer. If the PDCCH is detected, a corresponding DL-SCH transport block is transmitted to the higher layer. The higher layer analyzes the transport block and indicates a 20-bit UL Grant.

Some MTC UEs are installed in the basements of residential buildings or locations shielded by foil-backed insulation, metalized windows or traditional thick-walled building construction, and these UEs would experience significantly greater penetration losses on the radio interface than normal LTE devices. The MTC UEs in the extreme coverage scenario might have characteristics such as very low data rate, greater delay tolerance, and no mobility, and therefore some messages/channels may not be required.

Coverage enhancement for low-cost MTC UEs is described. It may be referred to Section 9 of 3GPP TR 36.888 V12.0.0 (2013-June). Performance evaluation of coverage enhancement techniques may be analyzed in terms of coverage, power consumption, cell spectral efficiency, specification impacts and, cost or complexity analysis. Not all UEs will require coverage enhancement, or require it to the same amount. It may be possible to enable the techniques only for the UEs that need it.

For coverage analysis, an additional coverage requirement of a 20 dB enhancement in comparison to “category 1 UEs” is targeted. Table 1 shows a minimum couple loss (MCL) table for category 1 UEs.

TABLE 1

| | Physical channel name | | | | | | |
|---|---|---|---|---|---|---|---|
| | PUCCH | | | | | | PDCCH |
| | (1A) | PRACH | PUSCH | PDSCH | PBCH | SCH | (1A) |
| MCL | 147.2 | 141.7 | 140.7 | 145.4 | 149.0 | 149.3 | 146.1 |
| (FDD) | | | | | | | |
| MCL | 149.4 | 146.7 | 147.4 | 148.1 | 149.0 | 149.3 | 146.9 |
| (TDD) | | | | | | | |

Referring to Table 1, it can be expected when the amount of coverage enhancement becomes larger, all channels listed in Table 1 need to be improved. For example, if the amount equals 20 dB, all uplink and downlink channels need to be enhanced because the gap between maximum MCL and minimum MCL is 8.6 dB for FDD and 2.7 dB for TDD. Given that single receive radio frequency (RF) and bandwidth reduction may be used for MTC UEs, and these techniques would decrease downlink coverage, additional coverage enhancement needs to be considered to compensate this coverage loss.

Assuming an x dB coverage enhancement is desired, the limiting channel from Table 1 with the minimum MCL will need to be improved by x dB. Note that x dB coverage enhancement is with respect to category 1 UE at the data rate of 20 kbps. The other channels will require less enhancement, with the overall amount of compensation equal to x dB reduced by the difference between the MCL and the minimum MCL. The overall amount of compensation should also include the application of low-cost MTC techniques: single receive RF chain would require additional coverage compensation for all downlink channels, and reduction of maximum bandwidth may require additional coverage compensation for the (E)PDCCH and physical downlink shared channel (PDSCH).

Required system functionality for MTC UEs in coverage enhancement mode is assumed to include functionality needed for synchronization, cell search, power control, random access procedure, channel estimation, measurement reporting and DL/UL data transmission (including DL/UL resource allocation). A MTC user who moves around is unlikely to be out of coverage for long. Accordingly, target of coverage enhancement is primarily for delay tolerant low-cost MTC device which are not mobile. System functionality requirement for large delay tolerant MTC UE requiring enhanced coverage may be relaxed or simplified in comparison to that required by normal LTE UE. HARQ acknowledgement (ACK)/non-acknowledgement (NACK) for PUSCH transmission is carried by physical HARQ indicator channel (PHICH). Dependent on the technique(s) for coverage enhancement PHICH may or may not be required. Control format indicator (CFI) in physical control format indicator channel (PCFICH) is transmitted in each subframe and indicates the number of OFDM symbols used for transmission of control channel information. With some additional complexity in UE (e.g. decoding of control channel assuming different CFI) or higher-layer signaling (e.g. pre-configuration of CFI), PCFICH may be eliminated.

Various concepts for coverage enhancement are described. More energy can be accumulated to enhance coverage by prolonging transmission time. The existing transmission time interval (TTI) bundling and HARQ retransmission in data channel can be helpful. Note that since the current maximum number of UL HARQ retransmission is 28 and TTI bundling is up to 4 consecutive subframes, TTI bundling with larger TTI bundle size may be considered and the maximum number of HARQ retransmissions may be extended to achieve better performance. Other than TTI bundling and HARQ retransmission, repetition can be applied by repeating the same or different redundant version (RV) multiple times. In addition, code spreading in the time domain can also be considered to enhance coverage. MTC traffic packets could be RLC segmented into smaller packets. Very low rate coding, lower modulation order (binary phase shift keying (BPSK)) and shorter length cyclic redundancy check (CRC) may also be used. New decoding techniques (e.g. correlation or reduced search space decoding) can be used to enhance coverage by taking into account the characteristics of the particular channels (e.g., channel periodicity, rate of parameter changes, channel structure, limited content, etc.) and the relaxed performance requirements (e.g. delay tolerance).

More power can be used by the eNB on the DL transmission to a MTC UE (i.e. power boosting), or a given level of power can be concentrated into a reduced bandwidth at the eNB or the UE (i.e. power spectral density (PSD) boosting). The application of power boosting or PSD boosting will depend on the channel or signal under consideration.

The performance requirements for some channels can be relaxed considering the characteristics (e.g. greater delay tolerance) of MTC UEs at extreme scenarios. For the synchronization signal, MTC UEs can accumulate energy by combining primary synchronization signal (PSS) or secondary synchronization signal (SSS) multiple times, but this will prolong acquisition time. For physical random access channel (PRACH), a loosened PRACH detection threshold rate and a higher false alarm rate at eNB could be considered.

New design of channels or signals for better coverage is possible if implementation based schemes cannot meet coverage enhancement requirement. These channels and signals, together with other possible link-level solution for coverage enhancement, are summarized in Table 2.

TABLE 2

| | Channels/Signals | | | | | |
|---|---|---|---|---|---|---|
| | PSS/ | | | | PDSCH/ | |
| Solutions | SSS | PBCH | PRACH | (E)PDCCH | PUSCH | PUCCH |
| PSD boosting | X | X | X | X | X | |
| Relaxed requirement | X | | X | | | |
| Design new channels/signals | X | X | X | X | X | |
| Repetition | | X | X | X | X | X |
| Low rate coding | | X | | X | X | X |
| TTI bundling/Retransmission | | | | | X | |
| Spreading | | X | | | X | |
| RS power boosting/ | | X | | X | X | |
| increased RS density | | | | | | |
| New decoding techniques | | X | | | | |

Coverage enhancements using link improvements must be provided for scenarios where no small cells have been deployed by the operator. An operator may deploy traditional coverage improvement solutions using small cells (including pico, femto, remote radio head (RRH), relays, repeaters, etc.) to provide coverage enhancements to MTC and non-MTC UE's alike. In deployments with small cells, the path loss from the device to the closest cell is reduced. As a result, for MTC UEs, the required link budget can be reduced for all channels.

For deployments that already contain small cells, there may be a benefit to further allow decoupled UL and DL for delay tolerant MTC UEs. For UL, the best serving cell is chosen based on the least coupling loss. For DL, due to the large Tx power imbalance (including antenna gains) between the macro and lower power node (LPN), the best serving cell is the one with maximum received signal power. This UL/DL decoupled association is feasible for MTC traffic especially for services without tight delay requirements. To enable UL/DL decoupled operation either in a UE-transparent or non-transparent manner, macro serving cell and potential LPNs may need to exchange information for channel (e.g. RACH, PUSCH, sounding reference signal (SRS)) configurations and to identify the suitable LPN. A different RACH configuration may be needed with decoupled UL/DL, from that without decoupled UL/DL.

Existing solutions that are deployed for coverage enhancement for “normal LTE UE” such as directional antennas, and external antennas can enhance coverage for MTC UE and normal UE alike.

As described above, repetition of each message may be considered as the basic method for coverage enhancement. Due to change of radio channel or movement of the UE, whether the coverage enhancement is required for the UE may be changed. For instance, if the UE is moved from the basement to the ground, the UE is likely to have better radio channel, and accordingly, the UE may no longer require the repetition. However, this change of coverage enhancement is unlikely known to the network so that the unnecessary repetition for the UE may happen.

In order to solve the problem describe above, a method for changing a coverage enhancement mode according to an embodiment of the present invention is described below.

In order let the network to know the change of coverage enhancement (hereafter refer to as CE) mode of the UE and change the supported coverage enhancement mode by the network, following method is proposed. According to one embodiment, the method comprises of determining the supported CE mode of the network, evaluating whether CE mode of the UE changes and requesting the change of the supported coverage enhancement mode.

For example, CE mode may be defined by whether the UE is required to perform repetition for uplink transmission and/or down reception. For another example, CE mode may be defined by CE level. The level in which the UE is required to have a certain amount of repetitions (resources) for uplink transmission and/or down reception. There is multiple CE level. In each level, the required number of repetitions (resources) is different. In this example, it may be assumed that the higher number of CE mode means the higher amount of repetitions (resources) are required. In other words, CE mode 3 requires more repetitions than CE mode 2.

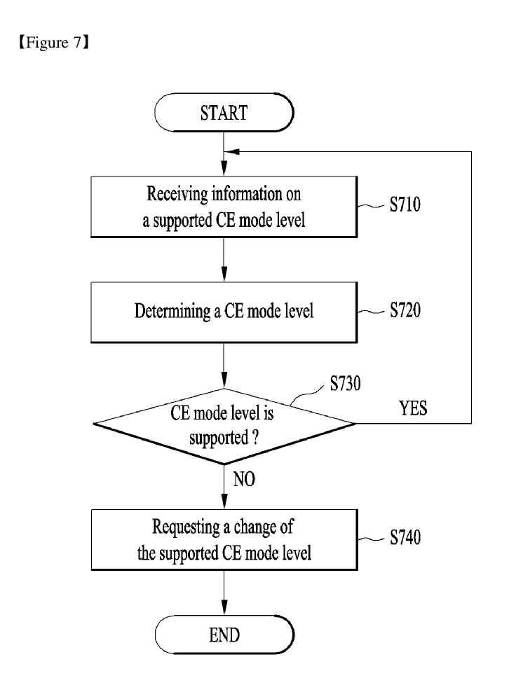

FIG. 7 shows an example of a method for changing a coverage enhancement mode according to an embodiment of the present invention.

Referring to FIG. 7, the UE may receive information on a supported CE mode level from a network (S710). For example, the UE determines the current supported CE mode level of the network by the provision of the currently supported CE mode level of the network. The network provides information on a currently supported CE mode level of the network. The network may also provide the information on maximum supported CE mode level of the network. For instance, the maximum supported CE mode level of the network is CE mode 3 while the currently supported CE mode level of the network is CE mode 2. The above information is provided via broadcast signaling (e.g. MIB, SIB1, PDCCH), which can be dedicated for CE mode UE.

After that, the UE may determine a CE mode level of the UE (S720).

According to one embodiment, the UE may determine its CE mode level based on various factors. First, the UE may determine its CE mode level based on the radio channel condition, such as referenced signal received power (RSRP) and/or referenced signal received quality (RSRQ). In this case, the measured signal level may be compared with the threshold signaled by the network.

For example, if RSRP (or RSRQ)<CE_low, coverage enhancement may be required, and if RSRP (or RSRQ)>CE_low, coverage enhancement may not be required. When multiple levels for the CE mode are defined, if RSRP (or RSRQ)<CE_thresh0, coverage enhancement with CE mode 0 may be required, if CE_thresh0≤RSRP (or RSRQ)<CE_thresh, coverage enhancement with CE mode 1 may be required, and so on.

In another example, the UE may determine its CE mode level based on essential system information acquisition period. If the UE cannot acquire essential system information for period T_sys, coverage enhancement may be required. Alternatively, if the UE performs N times trial of acquisition of essential system information but the UE cannot acquire, coverage enhancement may be required.

Alternatively, the UE may determine its CE mode level based on the number of repetition required for successfully receiving system information (e.g. master information block (MIB), system information block type1 (SIB1), SIB2 . . . ). For example, if the number of repetition required for receiving the essential system information is 1, coverage enhancement may not be required. If 1<the number of repetition required<thresh1, coverage enhancement with CE mode 1 may be required. If thresh1<the number of repetition required<thresh2, coverage enhancement with CE mode 2 may be required, and so on.

In another example, the UE may determine its CE mode level based on synchronization channel acquisition, i.e. primary synchronization signal (PSS)/secondary synchronization signal (SSS). As similar as the CE mode level determination method by using the system information described above, UE may determine its CE mode level based on the number of repetition required for detecting PSS/SSS. Or, if the UE cannot acquire synchronization channel successfully for period T_sys, coverage enhancement may be required.

In another example, the UE may determine its CE mode level based on synchronization channel acquisition, i.e. Physical layer control channel (PDCCH). In this case, physical layer control channel may be provided being adequate for highest CE mode level.

Alternatively, the number of repetition required for decoding PDCCH as in the above system information case. Additionally, multiple threshold value can be defined for differentiating the CE level.

Alternatively, if the UE cannot acquire sync channel successfully for period T_cont, coverage enhancement may be required. Additionally, multiple level of time threshold value is defined. For instance, if time to acquire PDCCH<T1, CE mode 1 may be required. If T1<Time to acquire PDCCH<T2, CE mode 2 may be required, and so on.

The UE may determine whether the CE mode level of the UE is supported by the supported CE mode level (S730). According to the determination result, if the CE mode level of the UE is supported by the supported CE mode level from the network, the UE may notify that the mode is changed. On the other hand, if the CE mode level of the UE is not supported by the supported CE mode level from the network, the UE may request a change of the supported CE mode level to the network (S740).

For example, CE mode change may indicate that the UE which was in coverage enhancement mode does not need to perform coverage enhancement mode any more. Alternatively, CE mode change may indicate that the UE which was not in coverage enhancement mode needs to perform coverage enhancement mode. CE mode change may indicate that the level of coverage enhancement mode changes. In other words, the required/expected amount of repetition (resources) for the UE changes (e.g. less or more amount of repetition (resources) is needed) compared to the amount required for the last successful transmission/reception.

According to one embodiment, the UE requests the change of the currently supported CE mode level of the network if the current CE mode level of the UE is not supported by the currently supported CE mode level of the network and/or the maximum supported CE mode level of the network is higher than the current CE mode level of the UE and/or the UE is not able to receive the subset of broadcast information (e.g SIB for cell (re)selection). In this case, if the current CE mode level of the UE is higher than or equal to the currently supported CE mode level of the network, the UE may assume that the UE is not supported by the currently supported CE mode level of the network.

The UE may request change of the currently supported CE mode level of the network using the one of the following methods.

In one embodiment, the UE may request change of the currently supported CE mode level based on random access.

First, the UE selects RACH resources (time/frequency/preamble) associated with the current CE mode level of the UE and transmit the preamble with the amount of repetitions associated with the current CE mode level (step 1). The network provides all the RACH resources associated with any CE mode levels lower than or equal to the maximum supported CE mode level. This is provided via broadcast signaling such as MIB, SIB1 which is provided with maximum supported CE mode level. The information broadcast signaling can be dedicated for UE in any CE mode level. Alternatively, the above RACH resources can be preconfigured.

After receiving the preamble, the network optionally provides the response message via Msg 2 (i.e. RAR) (step 2). The network provides preamble identifier and indication which denotes whether the change request is acknowledged or not. The message also includes the CE mode level of the network to which the network changes CE mode level. During the above operation, optionally the UE may start a timer when initiating the step1 of this method or when transmitting a first repetition of the preamble or when transmitting a last repetition of the preamble. The timer is configured by the network or fixed. During the timer is running, if UE receives response message including the preamble identifier of the UE or UE receives response message including the preamble identifier and the requested CE mode level or higher CE mode level, the UE considers the request is successful. The UE stops the timer if until the timer expiry, if UE does not receive response message including the preamble identifier of the UE or UE does not receive response message including the preamble identifier and the requested CE mode level or higher CE mode level. Also, The UE stops the timer if the UE receives the response message which denotes the request is rejected. Then, the UE stops the timer. If the timer is expired or stopped due to the above reason, the UE treats the cell as barred during a configured/fixed time and does not send the preamble during the timer is running in the cell.

Then, if RAR includes an uplink grant, the UE transmits Msg3 using new LCID indicating the Msg3 is requesting a higher CE mode level (step 3). Otherwise, the UE does not transmit Msg3. For each CE mode level, a new LCID can be allocated. If only one LCID is assigned for requesting a higher CE mode level, an exact CE mode level the UE is requesting is included in the payload of Msg3 or header. New cause value can be added in RRC connection request message. The new cause value indicates that the UE is requesting a higher CE mode level. This step of this method can be only performed if step1 and step2 of this method does not indicate any CE mode level information through random access resources/Msg2.

Subsequently, if the requested CE mode level information is included in Msg3, the network provides the Msg4 including CE mode level of the network to which the network changes CE mode level as an acknowledgement (step 4). Alternatively, the network provides MAC PDU included in Msg3 as an acknowledgement. Alternatively, the network provides the UE identity and indication denoting whether the request in Msg3 is accepted or not.

In the above method, without the further step3/step4 of this method, the procedure can be ended.

During the above operation, optionally the UE starts a timer when initiating the step3 of this method or when transmitting a first repetition of the Msg3 or when transmitting a last repetition of the Msg3. The timer is configured by the network or fixed.

During the timer is running, if UE receives Msg4 message including the identifier of the UE or UE receives Msg4 message including the preamble identifier and the requested CE mode level or higher CE mode level, the UE considers the request is successful.

The UE stops the timer if UE does not receive Msg4 message including the identifier of the UE or UE does not receive response message including the UE identifier and the requested CE mode level or higher CE mode level until the timer expiry. Also, The UE stops the timer if the UE receives the response message which denotes the request is rejected. Then, the UE stops the timer. If the timer is expired or stopped due to the above reason, the UE treats the cell as barred during a configured/fixed time and does not initiate the procedure of this method during the timer is running in the cell.

According to another embodiment, the UE may change the CE mode of the UE by the network command. For this, the network becomes aware of the necessity of changing the CE mode of a particular UE. The network may know whether the CE mode needs to be changed by (i) the reported serving cell RSRP/RSRQ (reported by UE), (ii) the change request of the CE mode of the UE (through any uplink PUCCH/PUSCH/MAC layer/RRC layer)—the request may include the UE identity and the requested CE mode. (iii) based on uplink channel quality after receiving the reference signal, or (iv) based on the number of uplink transmission of the message.

Then, the network commands the UE to change the CE mode of the UE. This command is provided through PDCCH, MAC layer (e.g. MAC CE) or RRC layer message. In a command, following information can be included one or more of (i) the new CE mode for the UE, (ii) the repetition number of the preamble/Msg3/Msg5 associated with new CE mode, (iii) the dedicated random access resource (preamble/time/frequency information), and (iv) the cell identity of the serving cell.

After receiving the above command, the UE performs one of the random access and Intra-cell handover. For example, performing random access, the UE initiates the random access based on the information provided from the network. Specifically, the UE sends the dedicated preamble to the network optionally using the time/frequency resources and configured repetition numbers. Alternatively, the UE selects the random access resources (time/frequency/preamble) associated with the CE mode provided in above command and proceed the random access procedure. The random access resources associated with each supported CE mode is provided in broadcast signaling. For another example, handover to the current serving cell is performed. The random access during intra-cell HO, the random access procedure is same as described above.

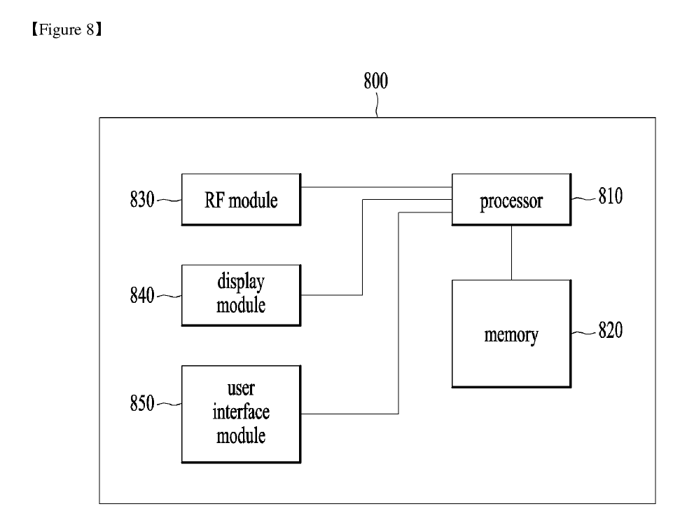

FIG. 8 is a block diagram for one example of a communication device according to one embodiment of the present invention.

Referring to FIG. 8, a communication device 800 includes a processor 810, a memory 820, an RF module 830, a display module 840 and a user interface module 850.

The communication device 800 is illustrated for clarity and convenience of the description and some modules can be omitted. Moreover, the communication device 800 is able to further include at least one necessary module. And, some modules of the communication device 800 can be further divided into sub-modules. The processor 810 is configured to perform operations according to the embodiment of the present invention exemplarily described with reference to the accompanying drawings. In particular, the detailed operations of the processor 810 can refer to the contents described with reference to FIGS. 1 to 7.

The memory 820 is connected to the processor 810 and stores operating systems, applications, program codes, data and the like. The RF module 830 is connected to the processor 810 and performs a function of converting a baseband signal to a radio signal or converting a radio signal to a baseband signal. For this, the RF module 830 performs analog conversion, amplification, filtering and frequency uplink transform or inverse processes thereof. The display module 840 is connected to the processor 810 and displays various kinds of information. The display module 840 can include such a well-known element as LCD (Liquid Crystal Display), LED (Light Emitting Diode), OLED (Organic Light Emitting Diode) and the like, by which the present invention is non-limited. The user interface module 850 is connected to the processor 810 and can include a combination of well-known interfaces including a keypad, a touchscreen and the like.

The above-described embodiments correspond to combination of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. It is apparent that an embodiment can be configured by combining claims, which are not explicitly cited in-between, together without departing from the spirit and scope of ‘what is claimed is’ or that those claims can be included as new claims by revision after filing an application.

In this disclosure, a specific operation explained as performed by a base station can be performed by an upper node of the base station in some cases. In particular, in a network constructed with a plurality of network nodes including a base station, it is apparent that various operations performed for communication with a terminal can be performed by a base station or other network nodes except the base station. In this case, ‘base station’ can be replaced by such a terminology as a fixed station, a Node B, an eNode B (eNB), an access point and the like.

Embodiments of the present invention can be implemented using various means. For instance, embodiments of the present invention can be implemented using hardware, firmware, software and/or any combinations thereof. In case of the implementation by hardware, a method according to one embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention can be applied to a wireless communication system which supports carrier aggregation. Specifically, the present invention can be applied to a method and an apparatus performing a coverage enhancement.

1-15. (canceled)

16. A method of communication based on a coverage enhancement (CE) mode by a user equipment (UE) in a wireless communication system, the method comprising:
receiving, from a network, information on a CE mode level of the UE;
selecting a random access resource based on the information on a CE mode level; and
performing a random access procedure using a random access resource.

17. The method of claim 16, wherein the number of repetitions required for preamble transmission is increased in accordance with an increase of a CE mode level.

18. The method of claim 16, wherein the information on a CE mode level is received via a physical downlink control channel (PDCCH).

19. The method of claim 16, wherein the performing a random access procedure includes transmitting a preamble with a number of repetitions determined according to the selected random access resource.

20. A user equipment (UE) in a wireless communication system, the UE comprising:
a radio frequency (RF) module configured to transmit/receive signals to/from a network; and
a processor configured to process the signals,
wherein the processor controls the RF module to receive, from a network, information on a CE mode level of the UE,
selects a random access resource based on the information on a CE mode level, and
performs a random access procedure using a random access resource.

21. The UE of claim 20, wherein the number of repetitions required for preamble transmission is increased in accordance with an increase of a CE mode level.

22. The UE of claim 20, wherein the information on a CE mode level is received via a physical downlink control channel (PDCCH).

23. The UE of claim 20, wherein the processor performing a random access procedure control the RF module to transmit a preamble with a number of repetitions determined according to the selected random access resource.
